(19) United States
(12) Patent Application Publication
(10) Pub. No.: US 2021/0270710 A1
(43) Pub. Date: Sep. 2, 2021

(54) SYSTEM FOR COMPOSITE MATERIAL DELAMINATION TESTING

(71) Applicant: Rolls-Royce Corporation, Indianapolis, IN (US)

(72) Inventor: Jason Baker, Avon, IN (US)

(21) Appl. No.: 16/806,472

(22) Filed: Mar. 2, 2020

(51) Int. Cl. G01N 3/20; G01N 3/02

(52) U.S. Cl. CPC G01N 3/20; G01N 3/02; G01N 2203/0262; G01N 2203/0062; G01N 2203/0226; G01N 2203/0023

(57) ABSTRACT

A system for composite material delamination testing at elevated temperatures is disclosed. The system includes a testing machine, means for increasing temperature of a test article, a specimen made from composite material, and a specimen mount for coupling the specimen to the testing machine. The specimen mount is configured to endure temperatures greater than ambient applied to the specimen so as to enable elevated temperature testing.

### FIELD OF THE DISCLOSURE

The present disclosure relates generally to material testing systems and methods, and more specifically to composite material testing.

### BACKGROUND

Delamination is a potential failure mode for designs incorporating composite materials. Coupon and subelement tests are used to calibrate and validate material behavior. In some physical testing systems a curved beam of composite material provides a test specimen that is intentionally bent to stress the composite material layers, which induces a delamination dominated failure. The C-specimen is one of those curved beam specimen designs that have been used in delamination testing.

Ceramic matrix composite (CMC) materials are being considered for use in high temperature applications because of their capabilities in hot environments. In particular, the use of CMC parts the hot section of turbine engines is of high interest. Material testing at high temperatures is desirable for validating the mechanical properties of CMC materials. This poses a problem for how to introduce mechanical loading into curved beams, like the C-specimen, while at high temperatures.

### SUMMARY

The present disclosure may comprise one or more of the following features and combinations thereof.

A system for composite material delamination testing at elevated temperatures is disclosed. The system includes a testing machine, means for increasing temperature of a test article, a specimen made from composite material, and a specimen mount for coupling the specimen to the testing machine. The specimen mount is configured to endure temperatures greater than ambient applied to the specimen so as to enable elevated temperature testing.

In illustrative embodiments, the specimen may be a C-specimen with a C-shape having two legs and a bend (radius) therebetween. The specimen may be made up of reinforcement layers suspended in matrix material to form the composite material of the specimen. In some embodiments, the specimen may be made from ceramic matrix composite materials.

In illustrative embodiments, the specimen mount may include bolts passing through legs of specimen. The bolts may then engage a holder block or elongated bar via threaded connection as part of a connection to the testing machine.

In illustrative embodiments, wherein each of the legs is shaped to include pass-through holes and bolt holes. Each pass-through hole is sized to allow the entirety of a bolt to pass therethrough. Each bolt hole is sized to allow only a threaded shaft of a bolt to pass through, while the head of a bolt is too large to pass through. Accordingly, the bolt head engages the leg around the bolt hole.

These and other features of the present disclosure will become more apparent from the following description of the illustrative embodiments.

### BRIEF DESCRIPTION OF THE DRAWINGS

FIG. 1 is a front elevation view of a prior art system for composite material delamination testing at ambient temperatures, showing that the system includes a hydraulic testing machine, a C-specimen having equal-length legs, and a specimen mount that can be coupled to the hydraulic testing machine as suggested in FIG. 2;

FIG. 2 is a detail view of the prior art C-specimen and specimen mount from FIG. 1 showing that the specimen mount includes an adhesive to attach holder blocks to the C-specimen so that the holder blocks can be gripped by jaws of the hydraulic testing machine;

FIG. 3 is a front elevation view of a second system for composite material delamination testing at elevated temperatures, showing that the system includes a hydraulic testing machine, a furnace for controlling test article temperature, a C-specimen having unequal-length legs, and a specimen mount that can be coupled to the hydraulic testing machine as suggested in FIG. 4;

FIG. 4 is a detail view of the C-specimen and specimen mount from FIG. 3 showing that the specimen mount includes clamps spaced along a longer leg of the C-specimen and a load bar arranged between the clamps configured to apply load along a shorter leg of the C-specimen through a load pad;

FIG. 5 is a front elevation view of a third system for composite material delamination testing at elevated temperatures, showing that the system includes a hydraulic testing machine, a furnace for controlling test article temperature, a C-specimen having equal-length legs, and a specimen mount that can be coupled to the hydraulic testing machine as suggested in FIG. 6;

FIG. 6 is a detail view of the C-specimen and specimen mount from FIG. 5 showing that the specimen mount includes bolts that extend through the legs of the C-specimen to engage with holder blocks that can be gripped by jaws of the hydraulic testing machine;

FIG. 7 is a perspective view of the C-specimen and bolts of the specimen mount from FIG. 6 showing that each leg of the C-specimen is formed to include a pair of pass-through holes and a pair of bolt holes to accommodate insertion of the bolts through associated legs;

FIG. 8 is a side elevation view of the C-specimen and bolts of FIGS. 6 and 7; and

FIG. 9 is a top plan view of the C-specimen and bolts of FIGS. 6-8.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

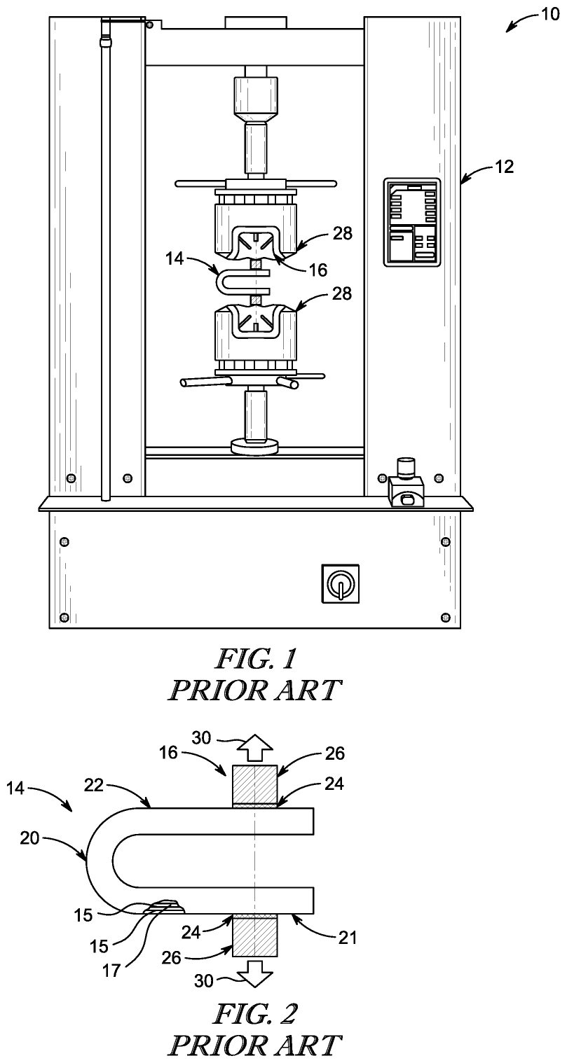

A prior art system 10 for composite material delamination testing at ambient temperatures is shown in FIG. 1. The system 10 includes a testing machine 12, a C-specimen 14, and a specimen mount 16.

The testing machine 12 is illustratively a hydraulic testing machine configured to apply controlled force to a test article so as to determine max force to failure, cyclic force to failure, or the like. Testing machine 14 and operation thereof is known in the art. The C-specimen 14 is illustratively coupled to the testing machine 12 by specimen mount 16 as suggested in FIG. 2.

C-specimen 14 is illustratively made from composite materials made up of a plurality of reinforcement layers 15 infiltrated with a matrix material 17 as suggested in FIG. 2. C-specimen 14 has a C-shape with legs 21, 22 interconnected by a bend 20. In the illustrated embodiment, legs 21, 22 are equal-length legs.

The specimen mount 16 includes an adhesive 24 configured to attach holder blocks 26 to the C-specimen 14 as shown in FIG. 2. The holder blocks 26 can be gripped by jaws 28 of the testing machine 12 or can be coupled to the testing machine 12 in other suitable ways. The holder blocks 26 are illustratively coupled via the adhesive 24 near the distal ends of the legs 21, 22 at a location spaced apart from the bend 20 so as to cause delamination of the layers 15 upon the application of test force, suggested by arrows 30. Use of adhesive 24 is suitable for testing at ambient (room) temperatures, but may not be suitable for mounting C-specimen 14 during testing at higher temperatures.

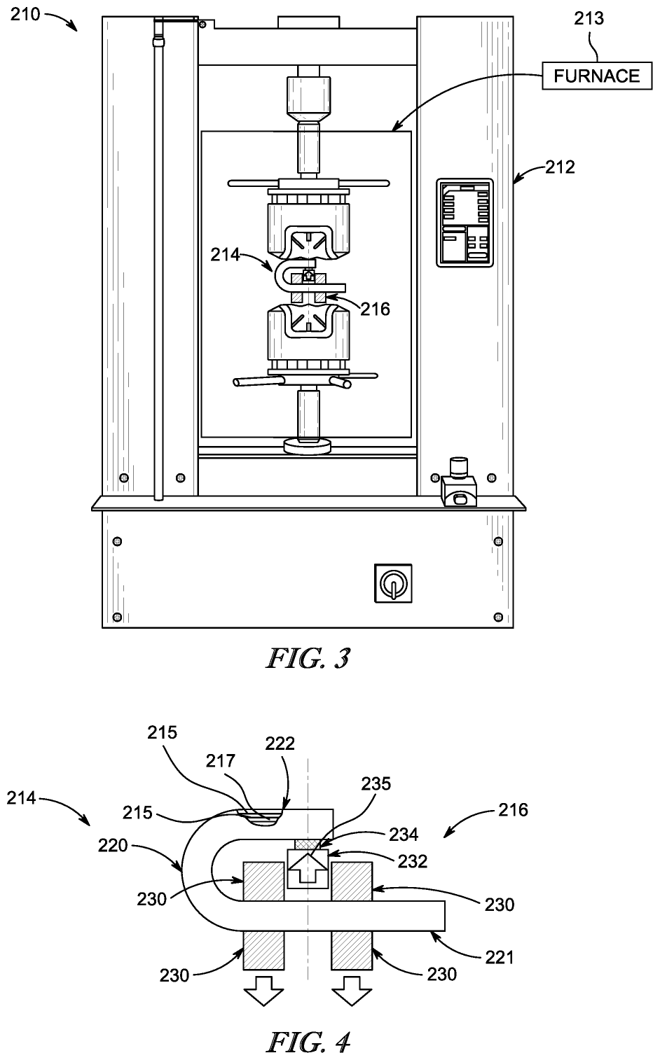

A second system 210 for composite material delamination testing at elevated temperatures is shown in FIGS. 2 and 3. The system 210 includes a hydraulic testing machine 212, a furnace 213, a C-specimen 214, and a specimen mount 216.

The testing machine 212 is illustratively a hydraulic testing machine configured to apply controlled force to a test article so as to determine max force to failure, cyclic force to failure, or the like. Testing machine 214 and operation thereof is known in the art. The C-specimen 214 is illustratively coupled to the testing machine 212 by specimen mount 216 as suggested in FIG. 4. Other testing machines are contemplated for applying force to a test article.

The furnace 213 is configured to provide means for raising and holding test article temperatures. Of course various temperature ranges and cycles are contemplated as may be desired for a particular test. Other suitable means for raising and/or holding test article temperature, such as heat guns, ovens, radiant heaters, etc. are also contemplated.

C-specimen 214 is illustratively made from composite materials made up of a plurality of reinforcement layers 215 infiltrated with a matrix material 217 as suggested in FIG. 4. In the illustrative embodiment, the C-specimen 214 is made from ceramic matrix composite materials. For example, the reinforcement layers 215 may be silicon-carbide in matrix 217 of silicon-carbide (SiC—SiC composite). C-specimen 214 has a C-shape with legs 221, 222 interconnected by a bend 220. In the illustrated embodiment, legs 221, 222 are unequal-length legs with leg 221 longer than leg 222.

The specimen mount 216 includes clamps 230 spaced along the longer leg 221 of the C-specimen 214 and a load bar 232 arranged between the clamps 230 as shown in FIG. 4. The load bar 232 is configured to apply load along the shorter leg 222 of the C-specimen 214 through a load pad 234 as suggested by arrow 235.

According to some embodiments of the system 210, a unique specimen mount 216 (sometimes called the mechanical connection or fixture) is provided. This mount 216 does not include adhesive/glue and can be used at high temperatures. However, the fixture 216 design can require a C-specimen 216 with different leg lengths 221, 222. The load can introduced to the C-specimen 214 through contact at the loading pad 234. Some testing results using the system 210 showed asymmetric delamination cracks, which can be undesirable depending upon methodology and result criteria.

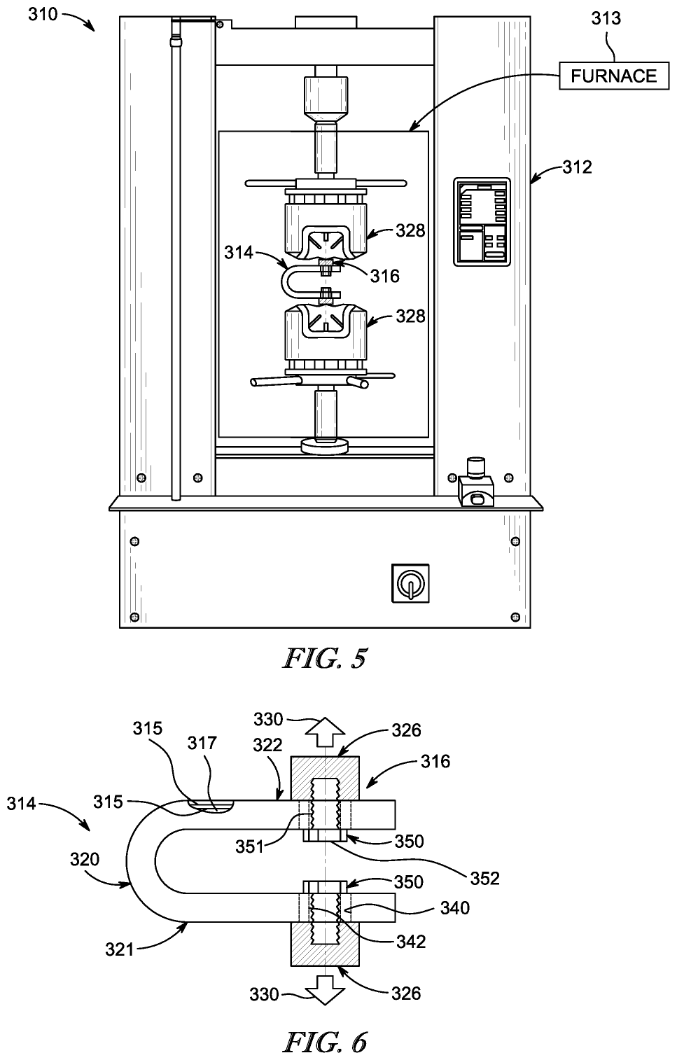

A third system 310 for composite material delamination testing at elevated temperatures is shown in FIG. 5. The system includes a testing machine 312, a furnace 313 for controlling test article temperature, a C-specimen 314, and a specimen mount 316.

The testing machine 312 is illustratively a hydraulic testing machine configured to apply controlled force to a test article so as to determine max force to failure, cyclic force to failure, or the like. Testing machine 312 and operation thereof is known in the art. The C-specimen 314 is illustratively coupled to the testing machine 312 by specimen mount 316 as suggested in FIG. 4.

The furnace 313 is configured to provide means for raising and holding test article at high temperatures. Other suitable means for raising and/or holding test article temperature, such as heat guns, ovens, radiant heaters, etc. are also contemplated.

C-specimen 314 is illustratively made from composite materials made up of a plurality of reinforcement layers 315 infiltrated with a matrix material 317 as suggested in FIG. 6. In the illustrative embodiment, the C-specimen 314 is made from ceramic matrix composite materials. For example, the reinforcement layers 315 may be silicon-carbide in matrix 317 of silicon-carbide (SiC—SiC composite). C-specimen 314 has a C-shape with legs 321, 322 interconnected by a bend 320. In the illustrated embodiment, legs 321, 322 are equal-length legs.

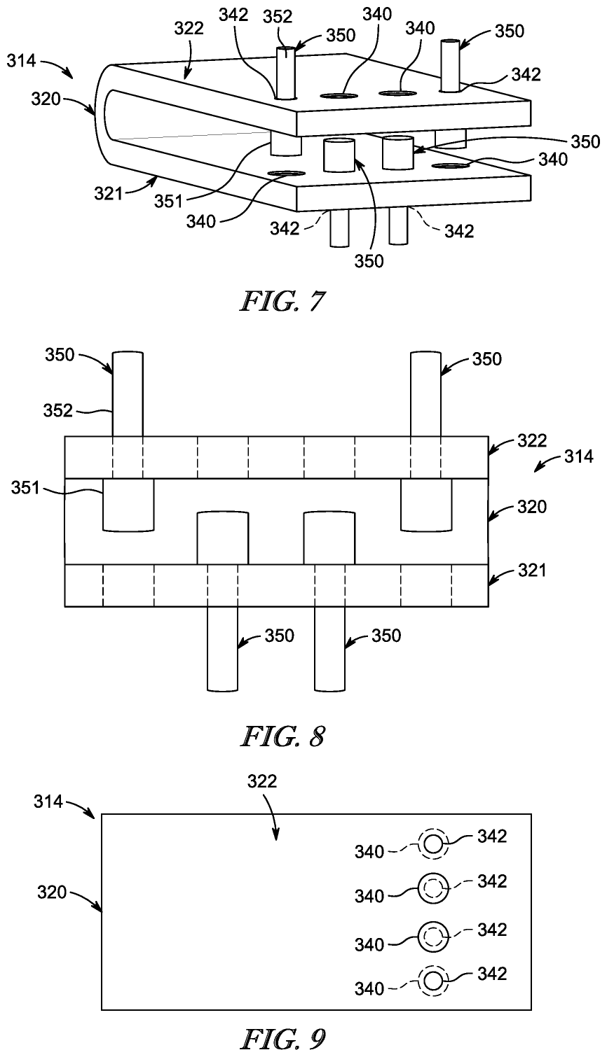

Each of the legs 321, 322 is shaped to include a pair of pass-through holes 340 and a pair of bolt holes 342 as shown in FIGS. 6-9. Each pass-through hole 340 is sized to allow the entirety of a bolt 350 to pass therethrough. Each bolt hole 342 is sized to allow only a threaded shaft 351 of an associated bolt 350 to pass through while a head 352 of an associated bolt 350 is too large to pass through. In this way, bolts 350 are assembled by passing through a pass-through hole 340 and engaging a leg 321, 322 around a bolt hole 342 as suggested in FIGS. 6-9. In the illustrative embodiment, the center line of all pass-through holes 340 and bolt holes 342 are spaced the same distance from the bend 320 of the C-specimen.

In the illustrated embodiment, the specimen mount 316 includes the bolts 350 that extend through the legs 321, 322 of the C-specimen 314 as shown in FIG. 5. The bolts 350 illustratively engage with holder blocks 326 that can be gripped by jaws 328 of the testing machine 312. In other embodiments, the bolts 350 can be directly engaged with the testing machine 312 or otherwise coupled to the testing machine 312. The holder blocks 26 can then be use to apply test force, suggested by arrows 330.

As part of setting up system 310, one may drill small holes straight through both legs 321, 322 at the desired load line position. There will be four holes on the top leg 322 and four holes on the bottom leg 321. All holes must be symmetric in the specimen width direction. Then, some smaller holes will be expanded to larger holes as follows: the two center holes on one leg and two outer holes on the other leg. The large hole (now a pass-through hole 340) must be big enough to pass a bolt head 352 completely through one leg yet mate against the opposite leg. In a preferred embodiment, there will be a total of four bolts 350: two for the top leg 322 and two for the bottom leg 321. These bolts 350 are the means to attach the load train of the mechanical test machine 312. The holes 340 342 introduce a stress concentration but if the C-specimen 314 is sufficiently sized then the bending stress induced in the radius (or bend 320) will dominate the failure modes.

Note that half of the holes on the upper and lower legs 321, 322 are big and the other half are small. Each bolt hole will correspond to a big hole, for which to pass the bolt head through, and a small hole for which the bolt head will contact the specimen leg and pass the bolt shank through the specimen to connect to the load train. The exact connect type for the load train can incorporate any suitable connector but it is suggested to simply use a small bar (or clamp block 326) that spans the width of the specimen. This configuration can have the advantages of 1) a mechanical attachment for high temperature testing, 2) symmetric loading for dominant failure mode, 3) and removes the uncertainty of friction.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A system for composite material delamination testing at elevated temperatures, the system comprising
a testing machine configured to apply controlled forces on a test article,
means for raising and holding test article temperatures above ambient temperatures,
a C-specimen made from composite materials with layers of reinforcement suspended in a matrix formed into a C-shape with a bend and legs extending from the bend, and
a specimen mount configured to couple the C-specimen to the testing machine without adhesives, the specimen mount including a plurality of bolts that extend through the legs of the C-specimen.

2. The system of claim 1, wherein each of the legs is shaped to include at least one pass-through hole and at least one bolt hole, each pass-through hole is sized to allow the entirety of a first bolt included in the plurality of bolts to pass therethrough, and each bolt hole is sized to allow only a threaded shaft of the first bolt to pass through while a head of the first bolt is too large to pass through.

3. The system of claim 2, wherein each leg is formed to include two pass-through holes and two bolt holes.

4. The system of claim 3, wherein the center of each pass-through hole and each bolt hole is spaced the same distance from the bend.

5. The system of claim 4, wherein legs of the C-specimen are of equal length.

6. The system of claim 1, wherein the means for raising and holding test article above ambient temperatures is provided by a furnace.
